(19) United States
(12) Patent Application Publication
(10) Pub. No.: US 2007/0154351 A1
(43) Pub. Date: Jul. 5, 2007

(54) BIO CARTRIDGE

(75) Inventors: Byeong-woo BAE, Anyang-si (KR); Sung-dong LEE, Yeongcheon-si (KR); Min-sun KIM, Seoul (KR); Jae-hyun YOO, Seoul (KR); Hyong-soo KIM, Suwon-si (KR)

Correspondence Address: CANTOR COLBURN, LLP, 55 GRIFFIN ROAD SOUTH, BLOOMFIELD, CT, 06002, US

(73) Assignee: INFOPIA CO., LTD., Anyang-si (KR)

(21) Appl. No.: 11/618,949

(22) Filed: Jan. 2, 2007

(30) Foreign Application Priority Data
Dec. 30, 2005 (KR) 1020050134914

(51) Int. Cl. G01N 21/00

(52) U.S. Cl. 422/58

(57) ABSTRACT

A bio cartridge measuring analytes contained in a test sample includes: a first measurement area provided to measure a first analyte contained in the test sample; a second measurement area provided to measure a second analyte contained in the test sample; a separation area provided to separate the first measurement area from the second measurement area; a sample channel shaped in capillary shape between the first and second measurement areas; an air outlet provided to discharge air when the test sample is filled in the first and second measurement areas; and an agitation unit mixing the test sample with a reactive sample in at least one of the first and second measurement areas, in which a reactive sample reacting with the first or second analyte is applied on an inner wall of at least one of the first and second measurement areas.

### CROSS REFERENCE TO RELATED APPLICATION

This application claims the benefit of and priority to Korean Patent Application No. 2005-134914, filed on Dec. 30, 2005, which is hereby incorporated by reference for all purposes as if fully set forth herein.

### BACKGROUND OF THE INVENTION

1. Field of the Invention

The present invention relates to a bio cartridge that optically detects two or more analytes contained in a test sample.

2. Discussion of the Background

In general, a method of measuring two or more analytes contained in a test sample includes sequentially adding and mixing a plurality of reactants with the test sample and measuring substances generated from reaction between the test sample and the reactants. In order to facilitate the above-mentioned method, a bio cartridge has been developed which includes all reactants required for measurement.

U.S. Pat. No. 5,162,237 discloses a bio cartridge in which a reactant isolated by a cover flows into a reactive channel of the bio cartridge, reacts with a test sample at one corner, and reacts with a test sample at another corner. In this case, measurement processes should be sequentially performed, and an operator should pull the cover so that the reactant can flow into the test sample.

U.S. Pat. No. 6,300,142 discloses an apparatus for measuring two or more analytes contained in a test sample, in which the test sample is injected through a first injection hole to react with a first reactant and is injected through a second injection hole to react with a second reactant. In this case, measurement processes should be sequentially performed, and an operator should sequentially inject the test sample to react with the reactants.

Accordingly, there is a problem in that two or more analytes cannot be measured at the same time and the operator should intervene in the measurement processes.

### SUMMARY OF THE INVENTION

The present invention provides a bio cartridge for measuring two or more analytes at the same time with reduced intervention of an operator.

The present invention further provides a method of manufacturing a bio cartridge and a method of measuring analytes contained in a test sample using the bio cartridge.

Additional features of the invention will be set forth in the description which follows, and in part will be apparent from the description, or may be learned by practice of the invention.

The present invention discloses a bio cartridge that measures analytes contained in a test sample, including: a first measurement area that is provided to measure a first analyte contained in the test sample; a second measurement area that is provided to measure a second analyte contained in the test sample; a separation area that is provided to separate the first measurement area from the second measurement area so that the test sample injected into the first measurement area cannot be mixed with the test sample injected into the second measurement area; a sample channel that is shaped in capillary shape between the first and second measurement areas to prevent the test sample injected into the second measurement area through the first measurement area from flowing backward to the first measurement area; an air outlet that is provided to discharge air so that air bubbles cannot be formed when the test sample is filled in the first and second measurement areas; and an agitation unit that mixes the test sample with a reactive sample in at least one of the first and second measurement areas, in which a reactive sample reacting with the first or second analyte is applied on an inner wall of at least one of the first and second measurement areas.

The agitation unit may be formed of an agitating plate that repeatedly moves left and right by an electromagnet provided on both sides of a measurement device.

The present invention also discloses a bio cartridge that measures analytes contained in a test sample, including: a first measurement area that is provided to measure first and second analytes contained in the test sample; a second measurement area that is provided to measure a second analyte contained in the test sample; a separation area that is provided to separate the first measurement area from the second measurement area so that the test sample injected into the first measurement area cannot be mixed with the test sample injected into the second measurement area; a sample channel that is shaped in capillary shape between the first and second measurement areas to prevent the test sample injected into the second measurement area through the first measurement area from flowing backward to the first measurement area; an air outlet that is provided to discharge air so that air bubbles cannot be formed when the test sample is filled in the first and second measurement areas; and an agitation unit that mixes the test sample with a reactive sample in the second measurement area, in which a reactive sample containing a plurality of magnetic beads applied with a reactant reacting with the second analyte is applied on an inner wall of the second measurement area.

The present invention also discloses a method of manufacturing a bio cartridge that measures analytes contained in a test sample, including: preparing a sample immobilization solution that fixes the reactive sample to an inner wall of a measurement area; applying on an inner wall of the second measurement area the sample immobilization solution that is mixed with a reactive sample reacting with the second analyte; drying the reactive sample by drying part of the bio cartridge that includes the second measurement area applied with the reactive sample; and joining the part of the bio cartridge with the remaining part of the bio cartridge.

The present invention also discloses a method of measuring analytes contained in a test sample with a bio cartridge, including: injecting into the bio cartridge the test sample obtained by mixing blood with a diluted solution; measuring the first analyte by making optical measurement of the test sample with a measurement device without reaction with the reactive sample in the first measurement area; mixing the reactive sample with the test sample by operating the measurement device to move the agitation unit right and left; measuring the second analyte by an optical measurement method after a predetermined time period required for reaction between the reactive sample and the test sample; and calculating a measured value of the analyte from measured values of the first and second analytes.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a bio cartridge according to an exemplary embodiment of the present invention.

FIGS. 2A to 2E are front view, left-side view, right-side view, plan view, and referential view of a bio cartridge according to an exemplary embodiment of the present invention.

FIGS. 3A and 3B are graphs showing experimental results of a bio cartridge according to an exemplary embodiment of the present invention.

FIGS. 4A to 4D are front view, left-side view, right-side view, plan view, and referential view of a bio cartridge according to an exemplary embodiment of the present invention.

FIGS. 5A and 5B are graphs showing experimental results of a bio cartridge according to an exemplary embodiment of the present invention.

FIGS. 6A to 6B are front view and referential view of a bio cartridge according to an exemplary embodiment of the present invention.

FIGS. 7A to 7E are front view, left-side view, right-side view, plan view, and referential view of a bio cartridge according to an exemplary embodiment of the present invention.

FIG. 8 is a graph showing experimental results of a bio cartridge according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

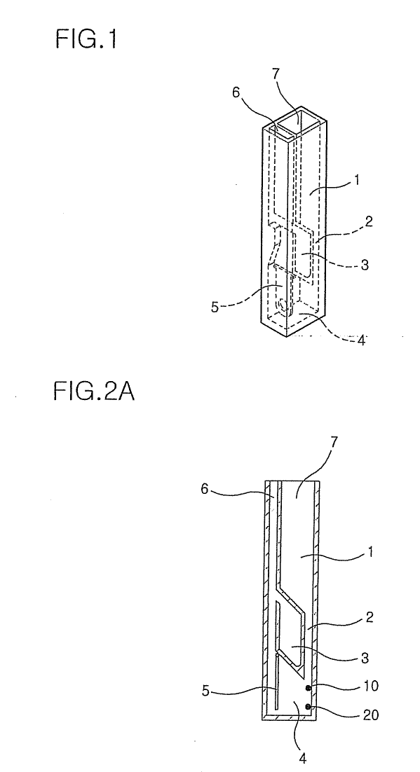

FIG. 1 shows a bio cartridge according to an exemplary embodiment of the present invention.

The bio cartridge includes a first measurement area 1, a sample channel 2, a separation area 3, a second measurement area 4, an agitation unit 5, an air outlet 6, and a sample inlet 7. The bio cartridge can measure two or more analytes at the same time since test samples are injected to the first and second measurement areas 1 and 4 which are separated from each other by 5 the separation area 3. When the test samples are injected through the sample inlet 7, the samples are filled in the first and second measurement areas 1 and 4 through the sample channel 2.

The bio cartridge has transparent polyvinylchloride (PVC) and polycarbonate (PC) which are deposited on front and rear sides of the bio cartridge so that the analytes can be measured by spectroscopy.

In more detail, the first measurement area 1 is a space for measuring a first analyte contained in a test sample, and the second measurement area 4 is a space for measuring a second analyte contained in a test sample. The first and second areas 1 and 4 are separated from each other by the separation area 3. A reactive sample (not shown) is applied on an inner wall of the first or second measurement area 1 or 4 to measure the first or second analyte contained in the test sample. The sample channel 2 is a passage for guiding the test sample from the first measurement area 1 into the second measurement area 4. The sample channel 2 is shaped in capillary shape between the first and second measurement areas 1 and 4 to prevent the test sample in the second measurement area 4 from flowing backward to the first measurement area 1. As a result, the test sample injected in the first and second measurement areas 1 and 4 is not mixed with each other so that different analytes can be measured in the first and second measurement areas 1 and 4.

The agitation unit 5 includes an agitating plate that is designed to be moved by the magnetism of an electromagnet provided on both sides of a measurement device (not shown). The agitation unit 5 mixes the test sample with the reactive sample applied on the first measurement area 1 by alternating the magnetism of the electromagnet of the measurement device. The air outlet 6 is a passage for discharging air when the test sample is injected into the first and second measurement areas 1 and 4.

The measurement device includes a light-emitting unit and a light-receiving unit on each of the first and second measurement areas 1 and 4 to measure first and second analytes contained in the test sample.

A structure of a bio cartridge, a method of manufacturing the bio cartridge and a method of measuring analytes contained in a test sample using the bio cartridge according to an exemplary embodiment of the present invention will be described. In this embodiment, total hemoglobin (tHb) and hemoglobin A1c (HbA1c) are measured using latex beads.

Hemoglobin A1c is measured by the proportion of hemoglobin combined with glucose with respect to total hemoglobin. Accordingly, total hemoglobin and hemoglobin A1c are measured at the same time. Hemoglobin A1c is measured by a latex immunoagglutination inhibition method using latex-HbA1c ab that is a combination of latex bead and anti-HbA1c antibody.

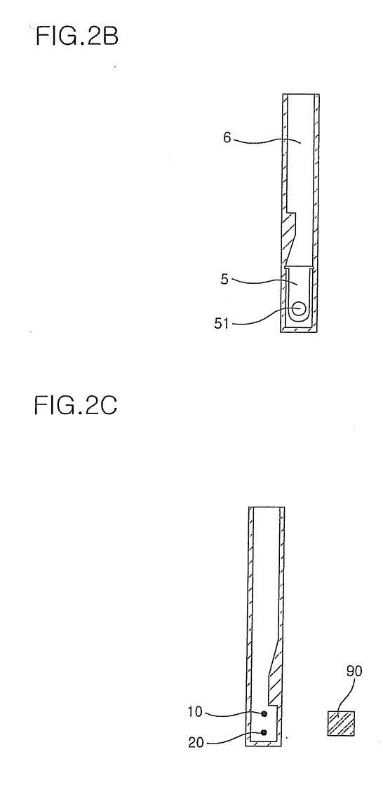

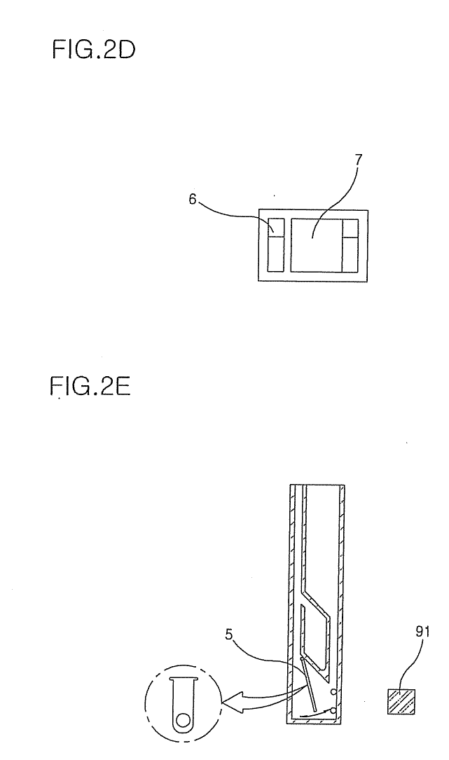

FIG. 2A is a front view of a bio cartridge according to a first embodiment of the present invention. FIGS. 2B and 2C are left-side and right-side views of the bio cartridge. FIG. 2D is a plan view of the bio cartridge. FIG. 2E is a referential view for explaining the operation of the bio cartridge.

A total hemoglobin level is measured in the first measurement area 1, and a hemoglobin A1c level is measured in the second measurement area 4. When a test sample is injected through the sample inlet 7, the test sample is filled in the first measurement area 1 and is filled in the second measurement area 4 through the sample channel 2. The sample channel 3 is shaped in a capillary shape, preventing the test sample in the second measurement area 4 from flowing backward to the first measurement area 1. Upon injection of the test sample, air remaining in the cartridge is discharged through the air outlet 6.

Since total hemoglobin is measured prior to reaction in the first measurement area 1, a reactive sample is not applied on the inner wall of the first measurement area 1. On the other hand, first and second reactive samples 10 and 20 are applied and dried on the inner wall of the second measurement area 4 such that the test sample reacts with latex-HbA1c ab. When the measurement device operates to alternate the magnetism of electromagnets 90 and 91, the agitation unit 5 operates to mix the test sample with the first and second reactive samples.

After a predetermined time interval required for the reaction, the total hemoglobin level and hemoglobin A1c level are measured by spectroscopy through light-emitting units and light-receiving units in the measurement device that are located at positions of the first and second measurement areas 1 and 4.

A method of manufacturing the bio cartridge thus structured will be described.

(1) Add 0.1% proclin150, 0.05% polyvinyl pyrrolidone (PVP) and 0.1% TritonX-100 to 100mM N-(2-hydroxyethyl)-piperazine-N′-2-ethanesulfonic acid, known as HEPES buffer, with pH8.1, to prepare a sample immobilization solution.

(2) Mix 0.5% latex-HbA1c ab with the sample immobilization solution, and drop the resultant solution of 10 ul on the first reactive sample 10 of the bio cartridge.

(3) Melt agglutinator in the sample immobilization solution prepared in the step (1) to become 40 ng, and drop the resultant solution of 10 ul on the second reactive sample 20 of the bio cartridge.

(4) Dry a lateral portion of the bio cartridge (see FIG. 2C) on which the first and second reactive samples are dropped, and bond the lateral portion of the bio cartridge with the remaining portion.

A method of measuring analytes with a bio cartridge according to the present embodiment of the invention will be described. (1) Put 1 ml of 50 mM HEPES buffer with pH 8.1 containing 0.025% sodiumlaurylsulfate (SLS), 0.05% TritonX-100, 0.05% polyethylene glycol (PEG) and 0.1% proclin150 in a tube to prepare a diluted solution.

(2) Obtain a test sample by mixing blood collected from a finger with the diluted solution and is injected into the bio cartridge.

(3) Measure a total hemoglobin level by operating a measurement device and performing color comparison measurement of the diluted test sample at a measurement wavelength of 531 nm in the first measurement area.

(4) Mix the test sample in the second measurement area with the first and second reactive samples by operating the agitation unit 5 by the measurement device.

(5) Measure a hemoglobin A1 c level by measuring the turbidity of the test sample and reactive samples in the second measurement area at a measurement wavelength of 531 nm about 8 minutes later by a latex immunoagglutination inhibition method.

(6) Calculate the proportion of hemoglobin A1 c from the total hemoglobin level measured in the first measurement area and the hemoglobin A1c level measured in the second measurement area.

The proportion of hemoglobin A1c is calculated from the following equation:
Proportion of hemoglobin A1c (%) Hemoglobin A1c /Total Hemoglobin×100 [Equation 1]

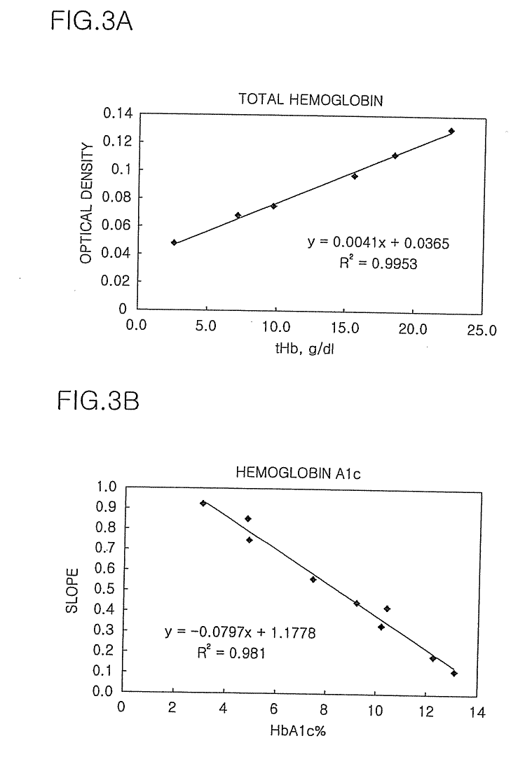

FIG. 3A is a graph showing measurement results of total hemoglobin level measured in the first measurement area by the above-mentioned method according to the above-mentioned embodiment of the present invention. FIG. 3B is a graph showing measurement results of hemoglobin A1c level measured in the second measurement area by the above-mentioned method according to the above-mentioned embodiment of the present invention.

A method of measuring two analytes at the same time according to a second embodiment of the present invention will be described. In more detail, a method of measuring total hemoglobin and glucose in blood through different enzyme reactions will be described.

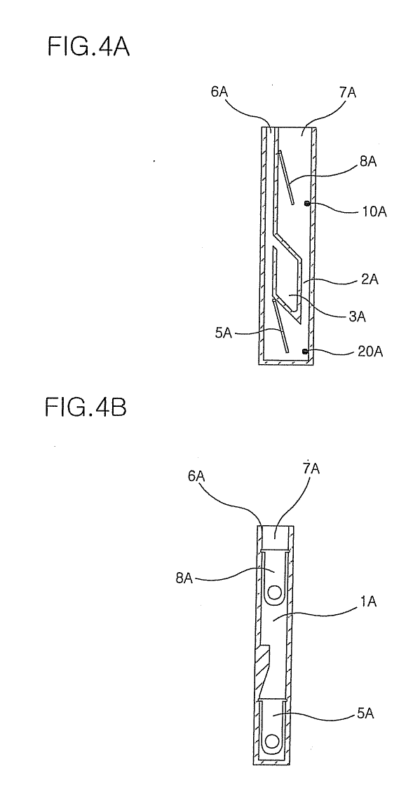

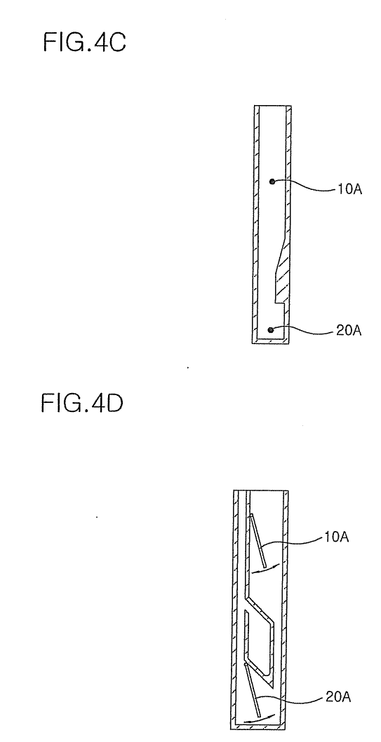

FIGS. 4A to 4D are front view, left-side view, right-side view, plan view, and referential view of a bio cartridge according to an exemplary embodiment of the present invention.

Referring to FIGS. 4A and 4B, a cholesterol level in blood is measured in the first measurement area 1A, and a glucose level in blood is measured in the second measurement area 4A. When a test sample is injected through a sample inlet 7A, the test sample is filled in the first measurement area 1A and in the second measurement area 4A through a sample channel 3A. The sample channel 3A is shaped in capillary shape to prevent the test sample in the second measurement area 4A from flowing backward to the first measurement area 1A. An air outlet 6A is provided to discharge air remaining in the cartridge upon injection of the test sample.

A first reactive layer 10A containing enzyme for measuring cholesterol is applied on the inner wall of the first measurement area 1A. A second reactive layer 20A containing enzyme for measuring glucose is applied on the inner wall of the second measurement area 4A. First and second agitation units 8A and 5A are provided in the first and second measurement areas 1A and 4A, respectively, to mix the test sample with the reaction layers. After a time period required for reaction, the cholesterol level and glucose level can be measured by spectroscopy through light-emitting unit and light-receiving unit of a measurement device (not shown) at the position of the first measurement area, and light-emitting unit and light-receiving unit of the measurement device at the position of the second measurement area.

A method of manufacturing the cartridge thus configured will be described in detail.

(1) Add 0.1% proclin150, 0.05% polyvinyl pyrrolidone (PVP) and 0.1% TritonX-100 to 50 mM KH₂PO₄ with pH7.1 to prepare a sample immobilization solution.

(2) Melt 40 u/ml cholesterol esterase (CHE), 20 u/ml cholesterol oxidase (COD), 40 u/ml peroxidase (POD), and 10 mM aminoantipyridine (4-AAP) in the sample immobilization solution, and drop the resultant solution of 10 ul on the first reactive sample 10A of the bio cartridge.

(3) Melt 1,800 u/ml glucose oxidase (GOx), 40 u/ml peroxidase (POD), 240 u/ml mutarotase (MUT), and 10 mM aminoantipyridine (4-AAP) in the sample immobilization solution prepared in the step

(1), and drop the resultant solution of 10 ul on the second reactive sample 20A of the bio cartridge.

(4) Dry a lateral portion of the bio cartridge (see FIG. 4C) on which the first and second reactive samples are dropped, and bond the lateral portion of the bio cartridge with the remaining portion.

A method of measuring analytes with the bio cartridge according to the present embodiment of the invention will be described.

(1) Put 1 ml of 50 mM KH₂PO₄ buffer with pH 7.1 containing 0.05% TritonX-100 and 50 mg/ml phenol in a tube to prepare a diluted solution.

(2) Obtain a test sample by mixing blood collected from a finger with the diluted solution and is injected into the bio cartridge.

(3) Mix the test sample with the first and second reactive samples by operating the agitation unit 5 by the measurement device.

(4) Perform a color comparison measurement of purple quinoneimin at a measurement wavelength of 500 nm about 5 minutes later in the first and second measurement areas.

(5) Measure the level of total hemoglobin contained in blood in the first measurement area, and measure the level of glucose contained in blood in the second measurement area.

Accordingly, it is possible to measure the total cholesterol level and glucose level in the first and second measurement areas, respectively, by the method of measuring a bio cartridge according to the above-mentioned embodiment of the invention.

A third embodiment of the present invention describes a method of measuring two analytes to compensate for a measured value of glucose by measuring the amount of hemoglobin. That is, a method of measuring total hemoglobin and glucose in blood will be described. In this case, the cartridge shown in FIGS. 2A to 2D may be used.

Referring to FIGS. 2A to 2E, a total hemoglobin level in blood is measured in the first measurement area 1, and a glucose level in blood is measured in the second measurement area 4. When a test sample is injected through the sample inlet 7, the test sample is filled in the first measurement area 1, and is filled in the second measurement area 4 through the sample channel 3. The sample channel 3 is shaped in capillary shape to prevent the test sample in the second measurement area 4 from flowing backward to the first measurement area 1. The air outlet 6 is provided to discharge air remaining in the cartridge upon injection of the test sample.

A reactive sample is not applied on the inner wall of the first measurement area 1 since total hemoglobin is measured prior to reaction in the first measurement area 1, while the second reactive layer 20 containing enzyme for measuring glucose is applied on the inner wall of the second measurement area 4. The agitation unit 5 is provided to mix the test sample and the reactive layer in the second measurement area. After a time period required for the reaction, the total hemoglobin level and glucose level can be measured by spectroscopy through light-emitting unit and light-receiving unit of a measurement device (not shown) at the position of the first measurement area, and light-emitting unit and light-receiving unit of the measurement device at the position of the second measurement area.

A method of manufacturing the cartridge thus configured will be described in detail.

(1) Add 50 mM arginin, 50 mM Trehalose, 0.1% proclin150, 0.05% polyvinyl pyrrolidone (PVP) and 0.1% TritonX-100 to 50 mM KH₂PO₄ with pH7.1 to prepare a sample immobilization solution.

(2) Melt 1,800 u/ml glucose oxidase (GOx), 40 u/ml peroxidase (POD), 240 u/ml mutarotase (MUT), 10 mM aminoantipyridine (4-AAP) and 50 mg/ml 3-(N-ethyl-m-toluidino)propanesulfonic acid (TOPS) in the sample immobilization solution prepared in the step (1), and drop the resultant solution of 10 ul on the second reactive sample 20 of the bio cartridge.

(3) Dry a lateral portion of the bio cartridge (see FIG. 2C) on which the second reactive sample is dropped, and bond the lateral portion of the bio cartridge with the remaining portion.

A method of measuring analytes with the bio cartridge according to the present embodiment of the invention will be described.

(1) Put 1 ml of 50 mM KH₂PO₄ buffer with pH 7.1 containing 0.05% TritonX-100 in a tube to prepare a diluted solution.

(2) Obtain a test sample by mixing blood collected from a finger with the diluted solution and is injected into the bio cartridge.

(3) Measure a total hemoglobin level by operating a measurement device and performing color comparison measurement of the diluted test sample at a measurement wavelength of 531 nm in the first measurement area.

(4) Mix the test sample with the reactive sample by operating the agitation unit 5 by the measurement device.

(5) Perform a color comparison measurement of purple quinoneimin at a measurement wavelength of 530 nm about 3 minutes later in the second measurement area.

(6) Calculate glucose level (mg/dl) from the total hemoglobin level measured in the first measurement area and the glucose level measured in the second measurement area. The glucose level (mg/dl) is calculated by the following equation.
glucose level (mg/dl)=glucose+??total hemoglobin where ?? denotes a constant that is used to compensate for the glucose level. [Equation 2]

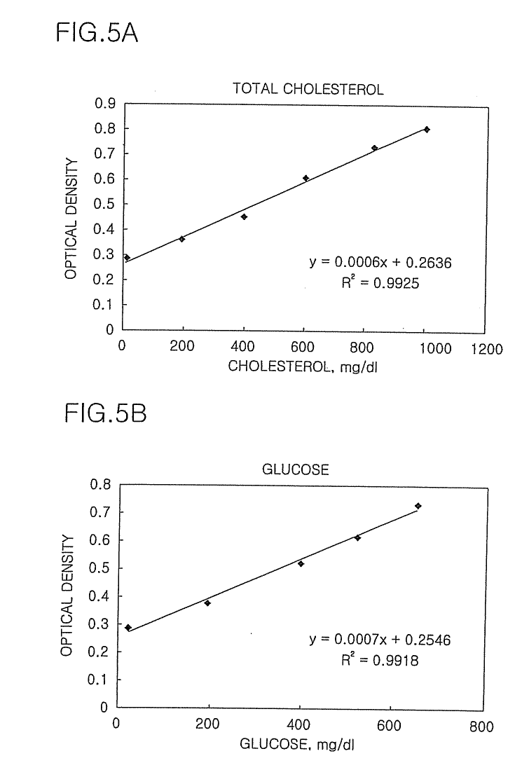

FIGS. 5A and 5B are graphs showing measurement results that are obtained by the method of measuring a bio cartridge according to the third embodiment. FIG. 5A shows measurement results of total hemoglobin level measured in the first measurement area. The glucose level (mg/dl) can be obtained from Equation 2.

A method of measuring total hemoglobin and hemoglobin A1c at the same time using a magnetic bead according to a fourth embodiment of the present invention will be described. Boronic acid (BA) is combined with the magnetic bead, and the method is performed through boronate affinity binding using a combination method of the boronic acid and cis-diol that is a tail of hemoglobin A1c.

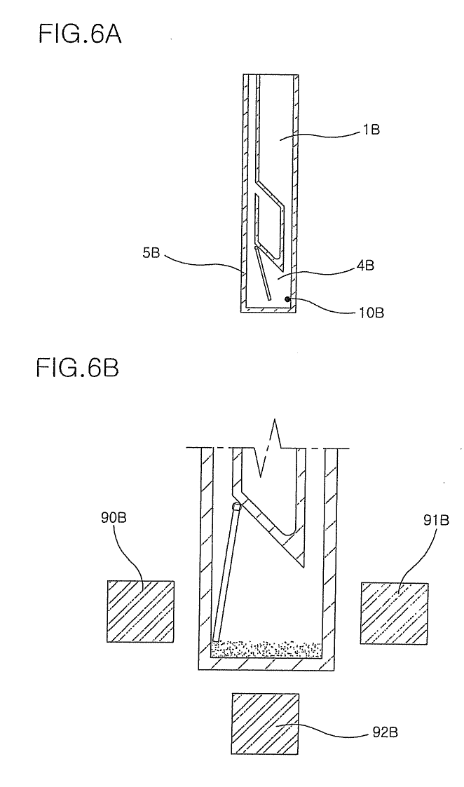

FIG. 6A is a front view of a bio cartridge according to an exemplary embodiment of the invention. FIG. 6B is a referential view for explaining the operation of a bio cartridge according to an exemplary embodiment of the present invention.

Both total hemoglobin and hemoglobin A1c contained in blood are simultaneously measured in a first measurement area 1B, and total hemoglobin level in blood is measured in a second measurement area 4B. When a test sample is injected through a sample inlet 7A, the test sample is filled in the first measurement area 1B, and is filled in the second measurement area 4B through a sample channel 3B.

A reactive sample is not applied in the first measurement area 1B, while a reactive sample 10B containing a plurality of magnetic beads 9B combined with boronic acid (BA) is applied on the inner wall of the second measurement area 4B. A measurement device is operated to change the magnetism of electromagnets 90B and 91B that are provided on left and right sides of the bio cartridge such that the test sample and the magnetic beads 9B contained in the reactive sample 10B are mixed with each other. In this case, cis-diol, which is a tail of hemoglobin A1c contained in the test sample, reacts with the boronic acid (BA) combined with the magnetic beads 9B. After a predetermined time interval required for the reaction, the electromagnet 92B provided on the bottom of the bio cartridge is magnetized such that the magnetic beads 9B are removed towards the bottom of the bio cartridge. The total hemoglobin level and hemoglobin A1c level are measured by spectroscopy through light-emitting units and light-receiving units of a measurement device (not shown) that are located at positions of the first and second measurement areas 1B and 4B. Accordingly, the total hemoglobin and hemoglobin A1c contained in blood are simultaneously measured in the first measurement area, and the total hemoglobin after the reaction is measured in the second measurement area.

A method of manufacturing the bio cartridge thus configured will be described in detail.

(1) Obtain a sample immobilization solution by adding 0.1% proclin150, 1.0% polyvinyl pyrrolidone (PVP) and 0.1% TritonX-100 to 20 mM N-(2-hydroxyethyl)-piperazine-N′-2-ethanesulfonic acid, known as HEPES buffer, with pH8.1.

(2) Mix 6% magnetic-aminophenylboronic acid (APBA) with the sample immobilization solution, and drop the resultant solution of 50 ul on the inner wall of the second measurement area.

(3) Dry a lateral portion of the bio cartridge on which the resultant solution is dropped such that the reactive sample containing the magnetic beads is dried, and bond the lateral portion of the bio cartridge with the remaining portion of the bio cartridge.

A method of measuring analytes with the bio cartridge according to an exemplary embodiment of the present invention will be described in detail.

(1) Put 1 ml of 20 mM HEPES buffer with pH 8.1 containing 0.1% saponin, 0.05% polyethylene glycol (PEG) and 0.1% proclin150 in a tube to prepare a diluted solution.

(2) Obtain a test sample by mixing 1 ul of blood collected from a finger with the diluted solution and is injected into the bio cartridge.

(3) Measure a total hemoglobin level and a hemoglobin A1c level at the same time by operating a measurement device and performing color comparison measurement of the diluted test sample at a measurement wavelength of 440 nm in the first measurement area.

(4) Mix the test sample in the second measurement area with a reactive sample 10B containing a plurality of magnetic beads 9B by operating an agitation unit 5B by the measurement device.

(5) Remove the magnetic beads 9B, i.e., the magnetic-APBA combined with the hemoglobin A1c existing in the second measurement area, towards the bottom of the bio cartridge about 8 minutes later by magnetizing the electromagnet 92B provided on the bottom of the bio cartridge.

(6) Measure the total hemoglobin level by performing a color comparison measurement of the solution remaining in the second measurement area at a measurement wavelength of 440 nm.

(7) Calculate the proportion of hemoglobin A1c from the total hemoglobin level (first measurement level) measured in the first measurement area, and the total hemoglobin level (second measurement level) measured in the second measurement area where the hemoglobin A1c is removed.

The proportion of hemoglobin A1c is calculated from the following equation:
Proportion of hemoglobin A1c (%) (first measurement level−second measurement level)/second measurement level×100 [Equation 3]

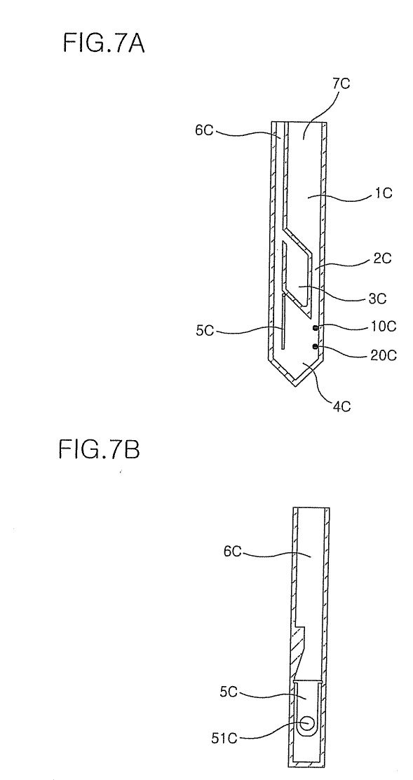

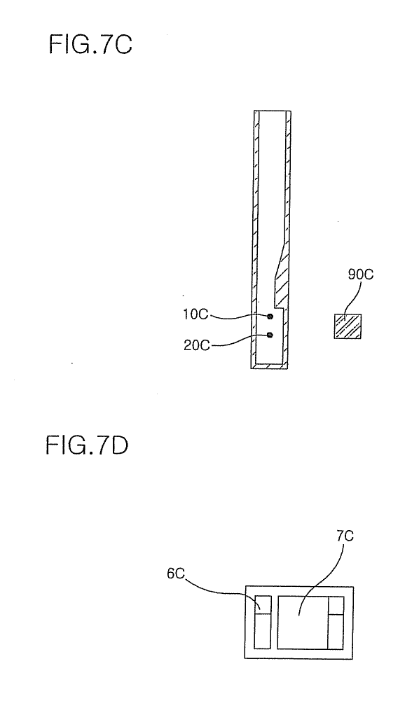

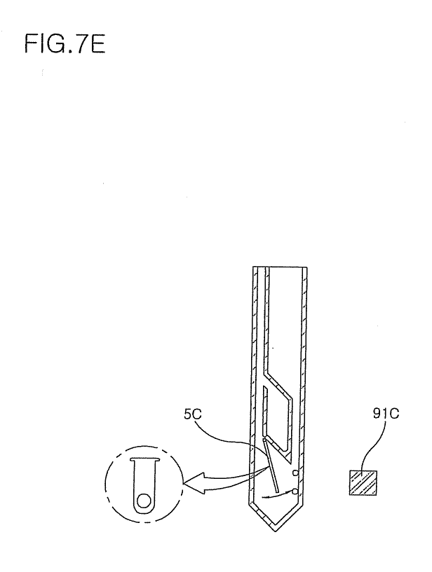

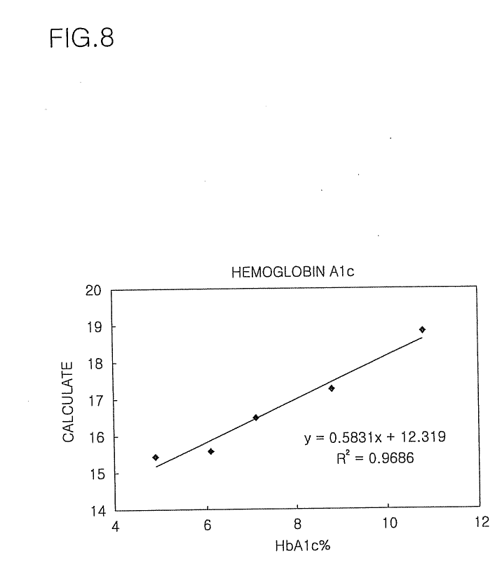

FIG. 7 shows measurement results that are obtained by the method of measuring a bio cartridge according to the above-mentioned embodiment of the invention. FIG. 7 shows the proportion of hemoglobin A1c that is calculated by the first and second measurement levels.

A method of simultaneously measuring total hemoglobin and hemoglobin A1c using an agarose bead according to a fifth embodiment of the invention will be described. Boronic acid (BA) is combined with the agarose bead, and the method is performed through boronate affinity binding using a combination method of the boronic acid and cis-diol that is the tail of hemoglobin A1c. The agarose bead is settled to the bottom by the force of gravity.

FIGS. 7A to 7E are front view, left-side view, right-side view, and plan view of a bio cartridge, and referential view for explaining the operation of the bio cartridge according to an exemplary embodiment of the present invention.

Both total hemoglobin and hemoglobin A1c contained in blood are simultaneously measured in a first measurement area 1C, and total hemoglobin in blood is measured in a second measurement area 2C. When a test sample is injected through a sample inlet 7C, the test sample is filled in the first measurement area 1C, and is filled in the second measurement area 4C through a sample channel 3C.

A reactive sample is not applied in the first measurement area 1C, while a reactive sample 10C including a plurality of agarose beads 9C combined with boronic acid (BA) is applied on the inner wall of the second measurement area 4C. A measurement device is operated to change the magnetism of electromagnets 90C and 91C that are provided on left and right sides of the bio cartridge such that the test sample and the agarose beads 9C contained in the reactive sample 10C are mixed with each other. Cis-diol, which is a tail of hemoglobin A1c contained in the test sample, reacts with boronic acid (BA) combined with the agarose beads 9C. After a predetermined time interval required for the reaction, the agarose beads 9C combined with the hemoglobin A1c are removed towards the bottom side of the bio cartridge by the force of gravity.

As shown in FIGS. 7A and 7E, the bottom surface of the bio cartridge is shaped in a corn shape so that the agarose beads can be easily settled to the bottom. In the above-mentioned embodiments, the bottom surface of the bio cartridge may be shaped in the corn shape.

The total hemoglobin level and hemoglobin A1c level are measured by spectroscopy through light-emitting units and light-receiving units in a measurement device (not shown) that are located at positions of the first and second measurement areas.

A method of manufacturing the bio cartridge thus configured will be described in detail.

(1) Obtain a sample immobilization solution by adding 0.1% proclin150, 1.0% polyvinyl pyrrolidone (PVP), 1.0% polyethylene glycol (PEG) and 0.1% TritonX-100 to 20 mM N-(2-hydroxyethyl)-piperazine-N′-2-ethanesulfonic acid, known as HEPES buffer, with pH8.1.

(2) Mix 6% agarose-aminophenylboronic acid (APBA) with the sample immobilization solution, and drop the resultant solution of 50 ul on the inner wall of the second measurement area.

(3) Dry a lateral portion of the bio cartridge on which the resultant solution is dropped such that the reactive sample containing the magnetic beads is completely dried, and bond the lateral portion of the bio cartridge with the remaining portion of the bio cartridge.

A method of measuring analytes with a bio cartridge according to an exemplary embodiment of the present invention will be described.

(1) Put 1 ml of 20 mM HEPES buffer with pH 8.1 containing 0.1% saponin, 0.05% polyethylene glycol (PEG) and 0.1% proclin150 in a tube to prepare a diluted solution.

(2) Obtain a test sample by mixing blood collected from a finger with the diluted solution and is injected into the bio cartridge.

(3) Measure the total hemoglobin level and hemoglobin A1c level at the same time by operating a measurement device and performing color comparison measurement of the diluted test sample at a measurement wavelength of 440 nm in the first measurement area.

(4) Mix the test sample in the second measurement area with a reactive sample 10B containing a plurality of agarose beads 9B by operating an agitation unit 5B by the measurement device.

(5) Stop operating the agitation unit 5B about 5 minutes later, and wait until the agarose beads 9B, which are the agarose-APBA combined with the hemoglobin A1c existing in the test sample, are settled to the bottom of the bio cartridge.

(6) Measure the total hemoglobin level by performing a color comparison measurement of the solution remaining in the second measurement area at a measurement wavelength of 440 nm.

(7) Calculate the proportion of hemoglobin A1c from the total hemoglobin level (first measurement level) measured in the first measurement area, and the total hemoglobin level (second measurement level) measured in the second measurement area where the hemoglobin A1c is removed.

The proportion of hemoglobin A1c is calculated from the following equation:
Proportion of hemoglobin A1c (%)=(first measurement level−second measurement level)/second measurement level×100 [Equation 4]

Instead of using the agarose beads, the above-mentioned measurement method may use other beads each having a diameter of 30 to 600 um that can be settled to the bottom by the force of gravity.

As apparent from the above description, the present invention provides a bio cartridge for measuring two or more analytes at the same time with reduced intervention of an operator. The present invention further provides a method of manufacturing a bio cartridge and a method of measuring analytes contained in a test sample using the bio cartridge.

That is, since the first and second measurement areas are separated from each other by the separation area and sample channel shaped in capillary shape so that the test sample injected into the measurement areas cannot be mixed with each other, it is possible to measure different analytes at the same time. In addition, since the agitation unit is provided in the first or second measurement area to mix the test sample with the reactant, it is possible to make an accurate measurement.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A bio cartridge that measures analytes contained in a test sample, comprising:
a first measurement area that is provided to measure a first analyte contained in the test sample;
a second measurement area that is provided to measure a second analyte contained in the test sample;
a separation area that is provided to separate the first measurement area from the second measurement area so that the test sample injected into the first measurement area cannot be mixed with the test sample injected into the second measurement area;
a sample channel that is shaped in capillary shape between the first and second measurement areas to prevent the test sample injected into the second measurement area through the first measurement area from flowing backward to the first measurement area;
an air outlet that is provided to discharge air so that air bubbles cannot be formed when the test sample is filled in the first and second measurement areas; and
an agitation unit that mixes the test sample with a reactive sample in at least one of the first and second measurement areas,
wherein a reactive sample reacting with the first or second analyte is applied on an inner wall of at least one of the first and second measurement areas.

2. The bio cartridge of claim 1, wherein the agitation unit is formed of an agitating plate that repeatedly moves left and right by an electromagnet provided on both sides of a measurement device.

3. The bio cartridge of claim 1, wherein the first analyte is total hemoglobin, the first measurement area is a space for measuring a total hemoglobin level, the second analyte is hemoglobin A1c combined with glucose, and the second measurement area is a space for measuring a hemoglobin A1c is level.

4. The bio cartridge of claim 3, wherein the reactive sample contains latex-HbA1c ab that is obtained by combining latex bead with anti-HbA1c antibody, and the hemoglobin A1c level is measured by a latex immunoagglutination method.

5. The bio cartridge of claim 4, wherein the proportion of hemoglobin A1c is calculated from the total hemoglobin level measured in the first measurement area and the hemoglobin A1c level measured in the second measurement area.

6. The bio cartridge of claim 1, wherein the first analyte is total cholesterol, the first measurement area is a space for measuring a total cholesterol level, the second analyte is glucose, and the second measurement area is a space for measuring a glucose level.

7. The bio cartridge of claim 6,
wherein a first reactive sample applied on the inner wall of the first measurement area contains cholesterol hydroxylase and cholesterol oxidase, and
a second reactive sample applied on the inner wall of the second measurement area contains glucose oxidase.

8. The bio cartridge of claim 7, wherein the total cholesterol level is measured using an enzyme reaction between the first reactive sample and the test sample, and the glucose level is measured using an enzyme reaction between the second reactive sample and the test sample.

9. The bio cartridge of claim 1, the first analyte is total hemoglobin, the first measurement area is a space for measuring a total hemoglobin level, the second analyte is glucose, and the second measurement area is a space for measuring a glucose level.

10. The bio cartridge of claim 9, wherein the second reactive sample applied on the inner wall of the second measurement area contains glucose oxidase.

11. The bio cartridge of claim 9, wherein the glucose level is measured using an enzyme reaction between the second reactive sample and the test sample.

12. The bio cartridge of claim 9, wherein an actual glucose level is calculated from the total hemoglobin level measured in the first measurement area and the glucose level measured in the second measurement area.

13. A bio cartridge that measures analytes contained in a test sample, comprising:
a first measurement area that is provided to measure first and second analytes contained in the test sample;
a second measurement area that is provided to measure a second analyte contained in the test sample;
a separation area that is provided to separate the first measurement area from the second measurement area so that the test sample injected into the first measurement area cannot be mixed with the test sample injected into the second measurement area;
a sample channel that is shaped in capillary shape between the first and second measurement areas to prevent the test sample injected into the second measurement area through the first measurement area from flowing backward to the first measurement area;
an air outlet that is provided to discharge air so that air bubbles cannot be formed when the test sample is filled in the first and second measurement areas; and
an agitation unit that mixes the test sample with a reactive sample in the second measurement area,
wherein a reactive sample containing a plurality of magnetic beads applied with a reactant reacting with the second analyte is applied on an inner wall of the second measurement area.

14. The bio cartridge of claim 13, wherein the first analyte is total hemoglobin, the second analyte is hemoglobin A1c, the first measurement area is a space for measuring total hemoglobin level and hemoglobin A1c level at the same time, and the second measurement area is a space for measuring a total hemoglobin level.

15. The bio cartridge of claim 14, wherein the reactant comprises boronic acid, concanavalin A, and antibody that can be combined with the hemoglobin A1c.

16. The bio cartridge of claim 14, wherein the magnetic beads applied with the reactant are removed towards the bottom of the second measurement area using an electromagnet after a predetermined reaction time.

17. The bio cartridge of claim 16, wherein the bottom of the second measurement area is shaped in plane or cone shape.

18. The bio cartridge of claim 14, wherein the proportion of hemoglobin A1c is calculated from the total hemoglobin level and hemoglobin A1c level measured in the first measurement area and the total hemoglobin level measured in the second measurement area.

19. A bio cartridge that measures analytes contained in a test sample, comprising:
a first measurement area that is provided to measure first and second analytes contained in the test sample;
a second measurement area that is provided to measure a second analyte contained in the test sample;
a separation area that is provided to separate the first measurement area from the second measurement area so that the test sample injected into the first measurement area cannot be mixed with the test sample injected into the second measurement area;
a sample channel that is shaped in capillary shape between the first and second measurement areas to prevent the test sample injected into the second measurement area through the first measurement area from flowing backward to the first measurement area;
an air outlet that is provided to discharge air so that air bubbles cannot be formed when the test sample is filled in the first and second measurement areas; and
an agitation unit that mixes the test sample with a reactive sample in the second measurement area,
wherein a reactive sample containing a plurality of beads with a diameter of 30 to 600 um applied with a reactant reacting with the second analyte is applied on an inner wall of the second measurement area.

20. The bio cartridge of claim 19, wherein the first analyte is total hemoglobin, the second analyte is hemoglobin A1c, the first measurement area is a space for measuring total hemoglobin level and hemoglobin A1c level at the same time, and the second measurement area is a space for measuring the total hemoglobin level.

21. The bio cartridge of claim 19, wherein the reactant comprises boronic acid, concanavalin A, and antibody.

22. The bio cartridge of claim 21, wherein a plurality of agarose beads applied with the reactant is removed towards the bottom of the second measurement area by the force of gravity after a predetermined reaction time.

23. The bio cartridge of claim 22, wherein the bottom of the second measurement area is shaped in plane or cone shape.

24. The bio cartridge of claim 20, wherein the proportion of hemoglobin A1c is calculated from the total hemoglobin level and hemoglobin A1c level measured in the first measurement area and the total hemoglobin level measured in the second measurement area.

25. A method of manufacturing a bio cartridge that measures analytes contained in a test sample and includes a first measurement area that is provided to measure a first analyte contained in the test sample; a second measurement area that is provided to measure a second analyte contained in the test sample; a separation area that is provided to separate the first measurement area from the second measurement area so that the test sample injected into the first measurement area cannot be mixed with the test sample injected into the second measurement area; a sample channel that is shaped in capillary shape between the first and second measurement areas to prevent the test sample injected into the second measurement area through the first measurement area from flowing backward to the first measurement area; an air outlet that is provided to discharge air so that air bubbles cannot be formed when the test sample is filled in the first and second measurement areas; and an agitation unit that mixes the test sample with a reactive sample in at least one of the first and second measurement areas, the method comprising:
preparing a sample immobilization solution that fixes the reactive sample to an inner wall of a measurement area;
applying on an inner wall of the second measurement area the sample immobilization solution that is mixed with a reactive sample reacting with the second analyte;
drying the reactive sample by drying part of the bio cartridge that includes the second measurement area applied with the reactive sample; and
joining the part of the bio cartridge with the remaining part of the bio cartridge.

26. A method of measuring analytes contained in a test sample with a bio cartridge that includes a first measurement area that is provided to measure a first analyte contained in the test sample; a second measurement area that is provided to measure a second analyte contained in the test sample; a separation area that is provided to separate the first measurement area from the second measurement area so that the test sample injected into the first measurement area cannot be mixed with the test sample injected into the second measurement area; a sample channel that is shaped in capillary shape between the first and second measurement areas to prevent the test sample injected into the second measurement area through the first measurement area from flowing backward to the first measurement area; an air outlet that is provided to discharge air so that air bubbles cannot be formed when the test sample is filled in the first and second measurement areas; and an agitation unit that mixes the test sample with a reactive sample in at least one of the first and second measurement areas, the method comprising:
injecting into the bio cartridge the test sample obtained by mixing blood with a diluted solution;
measuring the first analyte by making optical measurement of the test sample with a measurement device without reaction with the reactive sample in the first measurement area;
mixing the reactive sample with the test sample by operating the measurement device to move the agitation unit right and left;
measuring the second analyte by an optical measurement method after a predetermined time period required for reaction between the reactive sample and the test sample; and
calculating a measured value of the analyte from measured values of the first and second analytes.
